(19) United States
(12) Patent Application Publication
(10) Pub. No.: US 2017/0337541 A1
(43) Pub. Date: Nov. 23, 2017

(54) ENHANCED USER EXPERIENCE FOR LOW VALUE TRANSACTIONS

(71) Applicant: MasterCard International Incorporated, Purchase, NY (US)

(72) Inventors: Mehdi Collinge, Mont-Sainte-Aldegonde (BE); Patrik Smets, Nijlen (BE); Simon Phillips, York (GB)

(21) Appl. No.: 15/160,253

(22) Filed: May 20, 2016

(51) Int. Cl. G06Q 20/32; G06Q 20/10; G06Q 20/40

(52) U.S. Cl. CPC G06Q 20/3226; G06Q 20/4012; G06Q 20/102; G06Q 20/3221; G06Q 20/327

(57) ABSTRACT

A method includes completing a payment transaction using a payment-enabled mobile device. The method further includes prompting a user to perform a user authentication process with respect to the payment-enabled mobile device. The prompting occurs after completion of the payment transaction and prior to commencing another payment transaction using the payment-enabled mobile device.

### BACKGROUND

FIG. 1 is a block diagram that illustrates a conventional payment system 100.

The system 100 includes a conventional payment-enabled mobile device 102 that stores a payment card account number or payment token and runs a payment app, and emulates functionality of a contactless payment IC (integrated circuit) card. The system 100 further includes a reader component 104 associated with a POS terminal 106. The reader component 104 is capable of reading a payment card account number/payment token and other information from the payment-enabled mobile device 102. In some situations, the payment-enabled mobile device 102 runs an application to allow access to a payment token subject to user authentication by verification of the user's fingerprint via a fingerprint sensor on the mobile device. In addition to the pattern biometry user authentication approach represented by fingerprint sensing and verification, other types of biometry such as voice recognition, facial recognition, gait recognition and others have been proposed. Alternatively, user authentication may proceed by requiring input and verification of “something the user knows”, such as a PIN (personal identification number) or a password.

The reader component 104 and the POS terminal 106 may be located at the premises of a retail store and operated by a sales associate of the retailer for the purpose of processing retail transactions. The payment-enabled mobile device 102 is shown in FIG. 1 to be interacting with the reader component 104 and the POS terminal 106 for the purpose of executing such a transaction. Reference numeral 107 indicates a user/account holder who is a customer at the retail store and who has presented the payment-enabled mobile device 102 to the reader component in order to settle the retail transaction. In a typical transaction, the payment-enabled mobile device 102 is tapped by the user on a designated spot on the reader component 104 to trigger a contactless exchange of data communication between the reader component 104 and the payment-enabled mobile device 102.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment-enabled mobile device 102. As is also well known, the payment account transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account system transactions to be charged to payment accounts issued by the FI; and (b) tracking and storing transactions and maintaining account records.

The components of the system 100 as depicted in FIG. 1 are only those that are needed for processing a single transaction. A typical payment account system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment-enabled mobile devices and/or payment cards for initiating payment transactions by presenting an associated payment account number or payment token to the reader component of a POS terminal.

As is also well known, payment account numbers and/or payment tokens may also be employed in online shopping transactions. In such transactions, the user/customer may interact with a shopping website hosted by the merchant's e-commerce server computer (not shown). For such transactions, the merchant's e-commerce server computer may perform many of the functions described above with reference to the POS terminal 106. Such functions may include initiating a payment transaction authorization request message and receiving back a payment transaction authorization response message. It has been proposed for such transactions that, at least in some cases, the user may be required to successfully respond to a user authentication challenge via his/her mobile device before the online shopping transaction is permitted to go forward. According to some proposals, the user authentication may be biometric, including such biometric measures as fingerprint verification, voice recognition, facial recognition, gait recognition, etc. The user may also or alternatively employ a payment-enabled mobile device (such as item 102 in FIG. 1) to access a digital wallet function that facilitates the payment phase of an online transaction.

For many payment transactions utilizing payment-enabled mobile devices, it is customary to require “two factor” security—that is, the user must not only present a physical credential (the mobile device), but in addition a procedure must be followed to verify that the individual presenting the credential is authorized to do so. This additional required procedure is sometimes referred to in the payment card industry as a “cardholder verification method”, or “CVM”. The term “user authentication” is also sometimes used to refer to this type of procedure A widely used CVM prompts the user to enter a “PIN”, i.e., a “personal identification number”; for example this may be done via the user interface of the mobile device. If the PIN, as entered by the user, is determined to be correct, either on-device, locally, or at a remote server, then the CVM requirement is considered to have been satisfied. There are also known varieties of mobile device that include functionality to allow for scanning and verifying the user's fingerprint in order to accomplish user authentication. Still further, other types of biometric user authentication have been proposed, including facial recognition via an image of the user's face captured by a camera component of the mobile device.

In general, it may be necessary to make a trade-off between security of transactions—as supported for example by user authentication—versus convenience for the user. In striking a balance between transaction security and user convenience, it may be considered appropriate to allow certain classes of transactions to proceed without user authentication, while requiring user authentication for other transactions. For example, certain transactions may be designated as “low value transactions” (LVT) and allowed to take place without user authentication required for the transaction itself. For example, transactions below a threshold monetary amount such as (e.g.) 10 USD or 20 USD may be considered to be “low value”. Nevertheless, if low value transactions generally are allowed to be free of a user authentication requirement, risk management considerations may still call for there to be velocity limits and/or number-of-transaction limits such that an unlimited number of low value transactions are not permitted without raising an occasional user authentication requirement.

Again, however, the trade-off with user experience/convenience may arise with respect to the risk management limits on LVTs without user authentication. For example, if a current transaction exceeds a limit for LVT transactions, the user may be required to authenticate himself/herself during the transaction. The sequence of events that may occur is that the user taps the payment-enabled mobile device on the POS reader component, is prompted to perform user authentication, does so, and then is required to tap the payment-enabled mobile device on the POS reader component a second time. Such a sequence of events may be perceived as inconvenient for the user and may increase the time required to perform a transaction.

Moreover, some POS devices may not support the “dual-tap” scenario just described. Consequently, for such devices, after the first tap, plus the user authentication prompt and performance of the user authentication process, the entire transaction may be required to be re-entered to support a second, successful tap of the payment-enabled mobile device. A scenario as described in this paragraph may multiply the possible inconvenience arising from limits on LVTs without user authentication.

The present inventors have now recognized that there are opportunities to improve the trade-off between transaction security and user convenience with respect to LVT situations and the like.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates an example embodiment of a payment-enabled smartphone provided in accordance with aspects of the present disclosure.

FIG. 3 is a block diagram that illustrates a POS device that may be part of the environment in which aspects of the present disclosure may be applied.

FIG. 4 schematically illustrates a point-of-sale transaction environment in which aspects of the present disclosure may be applied.

FIG. 5 schematically illustrates a remote transaction environment in which aspects of the present invention may be applied.

FIG. 6 schematically illustrates aspects of a payment system environment in which aspects of the present invention may be applied.

FIGS. 7 and 8 are flow charts that illustrate processes that may be performed according to aspects of the present disclosure.

### DETAILED DESCRIPTION

In general, and for the purpose of introducing concepts of embodiments of the present disclosure, a payment-enabled mobile device may be programmed such that, upon completion of certain transactions, the user is prompted to perform user authentication in order to reset counters or otherwise satisfy risk management requirements relating to limits on the number of transactions that may be performed without user authentication. In this way, the transactions themselves are not disrupted and need not include user authentication steps, the user's convenience is maximized, and risk management objectives are met.

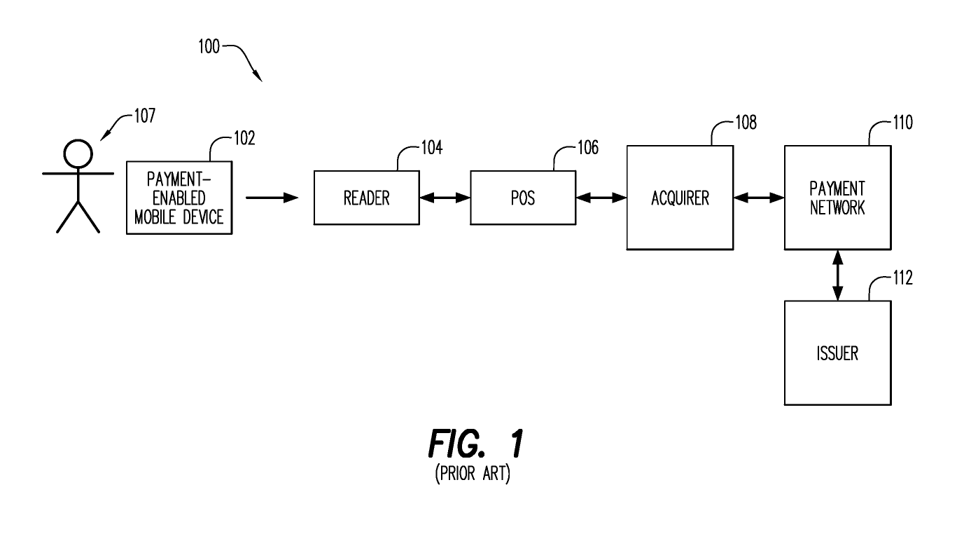

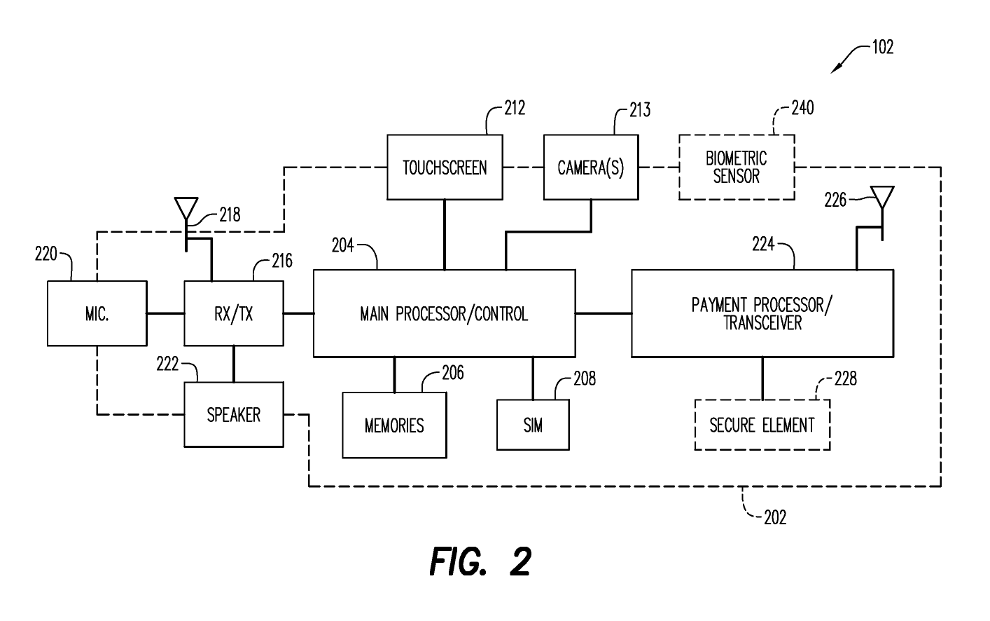

FIG. 2 is a block diagram that illustrates an example embodiment of the payment-enabled mobile device 102 shown in FIG. 1 (in this illustrative example, embodied as a smartphone) and provided in accordance with aspects of the present disclosure. The mobile device 102 may be conventional in its hardware aspects. For example, the mobile device 102 may resemble, in most or all of its hardware aspects and many of its functions, a conventional “iPhone” marketed by Apple Inc., or one of the numerous smartphone models that run the “Android” operating system.

The mobile device 102 may include a conventional housing (indicated by dashed line 202 in FIG. 2) that contains and/or supports the other components of the mobile device 102. The housing 202 may be shaped and sized to be held in a user's hand, and may for example exhibit the type of form factor that is common with the current generation of smartphones.

The mobile device 102 further includes conventional control circuitry 204, for controlling over-all operation of the smartphone 102. For example, the control circuitry 204 may include a conventional processor of the type designed to be the “brains” of a smartphone.

Other components of the mobile device 102, which are in communication with and/or controlled by the control circuitry 204, include: (a) one or more memory devices 206 (e.g., program and working memory, etc.); (b) a conventional SIM (subscriber identification module) card 208; and (c) a conventional touchscreen 212 which serves as the primary input/output device for the smartphone 102, and which thus receives input information from the user and displays output information to the user. As is the case with many models of smartphones, in some embodiments the mobile device 102 may also include a few physically-actuatable switches/controls (not shown), such as an on/off/reset switch, a menu button, a “back” button, a volume control switch, etc.

In some embodiments of the mobile device 102, as has become conventional, its components may include one or more cameras (reference numeral 213).

The mobile device 102 also includes conventional receive/transmit circuitry 216 that is also in communication with and/or controlled by the control circuitry 204. The receive/transmit circuitry 216 is coupled to an antenna 218 and provides the communication channel(s) by which the mobile device 102 communicates via the mobile telephone communication network (not shown). The receive/transmit circuitry 216 may operate both to receive and transmit voice signals, in addition to performing data communication functions.

The mobile device 102 further includes a conventional microphone 220, coupled to the receive/transmit circuitry 216. Of course, the microphone 220 is for receiving voice input from the user. In addition, a speaker 222 is included to provide sound output to the user, and is coupled to the receive/transmit circuitry 216.

The receive/transmit circuitry 216 may operate in a conventional fashion to transmit, via the antenna 218, voice signals generated by the microphone 220, and to reproduce, via the speaker 222, voice signals received via the antenna 218. The receive/transmit circuitry 216 may also handle transmission and reception of text messages and other data communications via the antenna 218.

In some embodiments, via a connection that is not explicitly shown, voice signals input by the user via the microphone 220 may be supplied in digital form to the control circuitry 204 or other processing capability of the mobile device 102 to allow for analysis of the voice signals by the mobile device 102.

The mobile device 102 may also include circuitry 224 that is partly or wholly dedicated to implementing the NFC communications circuitry functionality of the mobile device 102. The mobile device 102 may further include a loop antenna 226, coupled to the NFC circuitry 224. In some embodiments, the NFC circuitry 224 may partially overlap with the control circuitry 204 for the mobile device 102.

In some embodiments, the NFC circuitry 224 is associated with, and may also overlap with, a secure element 228. While secure elements have been proposed for incorporation with some payment-enabled smartphones, there have been other proposals that provide a desirable secure processing environment without a physically separate element. Accordingly, the secure element 228 is shown in phantom, as an optional component of the mobile device 102.

The term “secure element” is well known to those who are skilled in the art, and typically refers to a device that may include a small processor and volatile and nonvolatile memory (not separately shown) that are secured from tampering and/or reprogramming by suitable measures. In some embodiments, the secure element 228 may be provided as part of the SIM card 208. In other embodiments, the secure element 228 may be constituted by an integrated circuit card separate from the SIM card 208 but possibly having the same form factor as the SIM card 208. In some embodiments of the mobile device 102, the secure element 228 may be conventional in its hardware aspects but may be programmed in accordance with aspects of the present disclosure in a manner to be described below. (It should be noted that the term “secure element” is not intended to be limited to devices that are IC-based, but rather may also include any secure execution environment in a mobile device, and may include software based secure execution environments running on the main mobile device processor.) As an alternative to providing a physically-separate secure element, in some embodiments of the mobile device 102 the main control circuitry may be programmed to execute the payment processing functionality in full or in part with access from the mobile device 102 to a remote server (not shown in FIG. 2). As another alternative, one or more aspects of a conventional secure element may be implemented on the main processor of the mobile device 102. For example, in some embodiments the known technique of host card emulation (HCE) may be employed. In further embodiments, the payment functionality may reside in a Trusted Execution Environment (TEE).

In some embodiments, the mobile device 102 may further include a biometric sensor component 240 (shown in phantom). In some embodiments, if present, the biometric sensor component may resemble fingerprint scanning components of the type recently introduced in some models of smartphones.

As is familiar to those who are skilled in the art, the mobile device may be programmed with a number of application programs (“apps”), which are not separately indicated in FIG. 2. The apps may be stored in the memory components 206 and may program the control circuit/processor to perform various functions. These functions may include payment-related functions, including risk-management-related functions such as those taught in the present disclosure. For example, the apps may include a mobile payment application (not shown in FIG. 2), as discussed below, and supporting risk management functionality as disclosed herein.

The above-description of the payment-enabled mobile device has primarily been premised on the concept that the mobile device is embodied as a smartphone. However, other types of mobile devices, such as tablet computers, may also serve as payment-enabled mobile devices in accordance with the teachings of this disclosure. Moreover, payment-enabled devices may be provided in a variety of other form-factors, and may include, for example any or all of the payment devices that have been popularly referred to under the rubric of “The Internet of Payment Things” (IoPT). Thus a variety of wearable electronics, accessories and devices linked to mobile devices may also incorporate the functionality that is described herein in connection with payment-enabled smartphones.

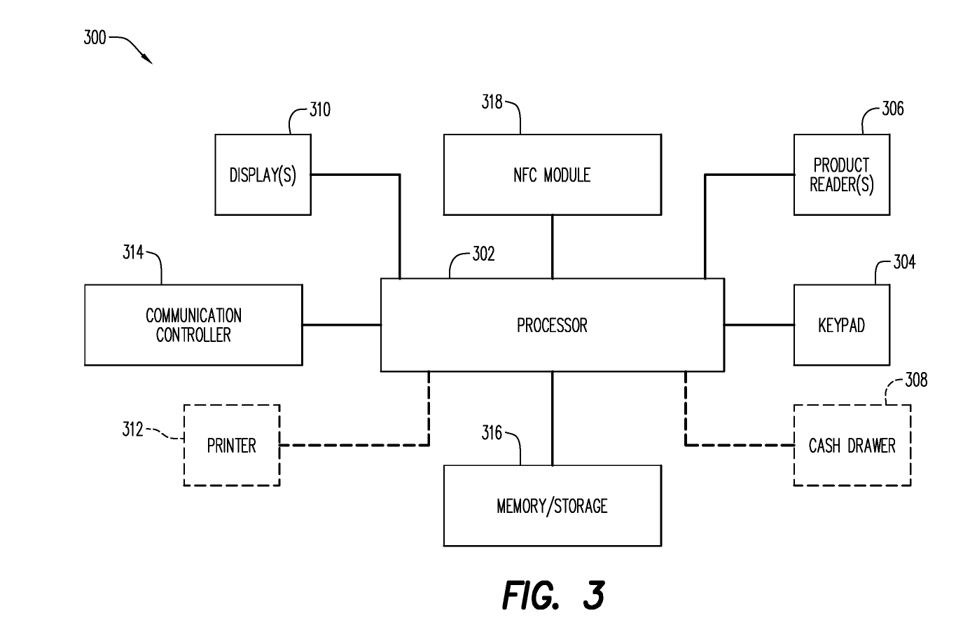

FIG. 3 is a block diagram that illustrates a POS device 300 that may be part of the environment in which aspects of the present disclosure may be applied. For example, the POS device 300 may correspond to the components 104 and 106 shown in FIG. 1.

In some embodiments, the POS device 300 may be largely or entirely conventional in its hardware aspects and also in its software aspects. The POS device 300 may include a processing element (or elements) such as the processor 302 shown in FIG. 3. The processor 302 may, for example, be a conventional microprocessor, and may operate to control the overall functioning of the POS device 300.

The POS device 300 may also include conventional peripheral components, in communication with and/or controlled by the processor 302, such as: (a) a keypad 304 for receiving input from the human operator of the POS terminal; (b) a product reader 306 for reading any form of unique product identifier, such as a barcode or RFID, that appears on, or is attached to, products brought to the terminal for purchase; (c) a cash drawer 308 for storing cash received from customers; (d) one or more displays 310 for providing output (e.g., identifying products presented for purchase and their prices, indicating sales tax due, indicating transaction subtotals and totals, etc., providing prompts to the customer and/or to the sales associate); (e) a printer 312 for printing out sales receipts; and (f) a communication controller 314 for allowing the processor 302, and hence, the POS device 300 to engage in communication over data networks with other devices (e.g., with a computer operated by a transaction acquirer/transaction processor). (In some embodiments, at least one of the displays 310 may be a touch screen, so as to provide an input function as well as an output function.)

In addition, the POS device 300 may include one or more memory and/or data storage devices (indicated collectively at 316), which may comprise any combination of one or more of a hard disk drive, RAM (random access memory), ROM (read only memory), flash memory, etc. The memory/data storage device(s) 316 may store software and/or firmware that programs the processor 302 and the POS device 300 to perform functionality commonly provided by POS devices. Thus the memory/data storage device(s) 316 may be in communication with the processor 302. Further, the POS device 300 may include one or more housings (not shown) which contain and/or support one or more of the other components shown in FIG. 3.

To enable short-range wireless data communications with the payment capabilities of the mobile device 102, the POS device 300 may include an NFC module (reference numeral 318). The NFC module 318 is in communication with the processor 302. In addition, though not shown in the drawing, suitable additional reader components may be associated with the POS device 300. Such reader components may include, for example, a magnetic stripe card reader, a contactless IC payment card reader and/or a contact IC payment card reader.

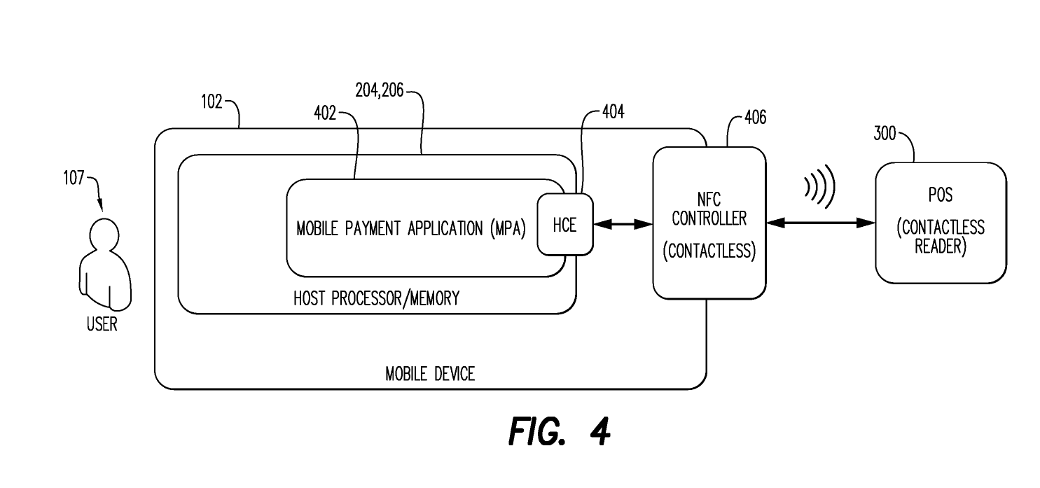

FIG. 4 schematically illustrates a point-of-sale transaction environment in which aspects of the present disclosure may be applied.

As in prior illustrations, reference numeral 300 indicates a POS device in FIG. 4, and reference numeral 102 represents a payment-enabled mobile device. The user of the mobile device 102 is indicated at 107. The control circuitry/memory components of the mobile device 102 are again indicated by reference numerals 204 and 206. A mobile payment application (app) is shown at 402. As schematically represented in FIG. 4, the mobile payment app 402 is stored in the mobile device memory and programs the mobile processor. In addition to conventional capabilities of a mobile payment app/wallet app, the mobile payment app 402 may have further capabilities, as provided in accordance with aspects of the present disclosure. For example, among the conventional capabilities of the mobile payment app 402 may be host card emulation (HCE), as referred to above, and represented at 404.

The payment-enabled mobile device 102 may engage in a contactless transaction communication process via an NFC controller 406 with the POS device 300. (The NFC controller 406, as shown in FIG. 4, may correspond at least in part with the element 224 shown in FIG. 2.) In some embodiments, the transaction communications that take place between the POS device 300 and the payment-enabled mobile device 102 may conform to the well-known EMV standard, or to another transaction communication standard currently in existence or adopted hereafter. As would be expected by those skilled in the art, information communicated from the payment-enabled mobile device 102 to the POS device 300 may include, for example, a payment account identifier (e.g., a primary account number or payment token) and/or a transaction cryptogram.

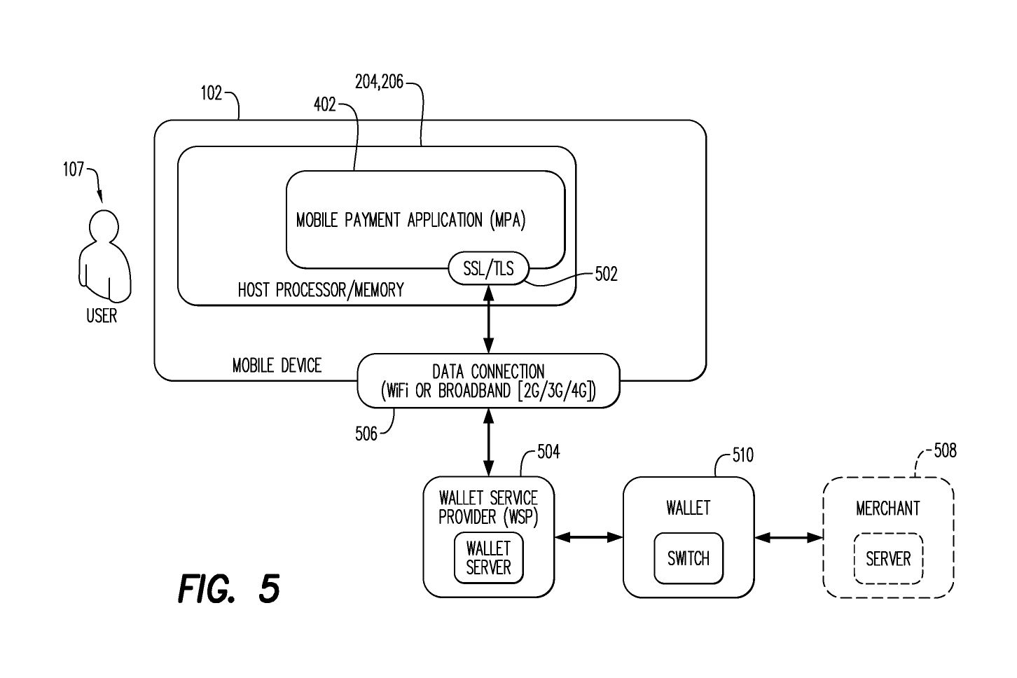

FIG. 5 schematically illustrates a remote transaction environment in which aspects of the present invention may be applied.

In FIG. 5, reference numeral 102 again indicates a payment-enabled mobile device and reference numeral 107 again indicates the device user. The mobile payment app 402 is also again shown, once more in association with the control circuitry/memory components 204,206.

Utilizing a security protocol such as SSL (Secure Sockets Layer) and/or TLS (Transport Layer Security) (both indicated by reference numeral 502), the mobile payment app 402 may interact with a remote wallet service provider (WSP) 504 via a suitable data connection supported by a corresponding data connection component 506 of the mobile device 102. (It will be understood that in some situations, at least, the data connection may be at least partly provided via a mobile network operator (MNO), which is not explicitly shown in the drawing.) The interaction between the mobile payment app 402 and the WSP 504 may be in support of a remote online shopping transaction to be consummated with a remote e-commerce server 508 operated by a merchant. A data connection between the WSP 504 and the e-commerce server 508 may be facilitated by a wallet switch server 510. To aid in consummating the online shopping transaction, the WSP 504 may supply the user's payment credentials (as selected by the user for this transaction) to the e-commerce server 508 via the wallet switch 510. The payment credentials may again include an account indicator such as a primary account number or a card-on-file payment token. In subsequent processing, the e-commerce server 508 may transmit a transaction authorization request and receive an authorization response, in a similar manner to that described above in connection with FIG. 1.

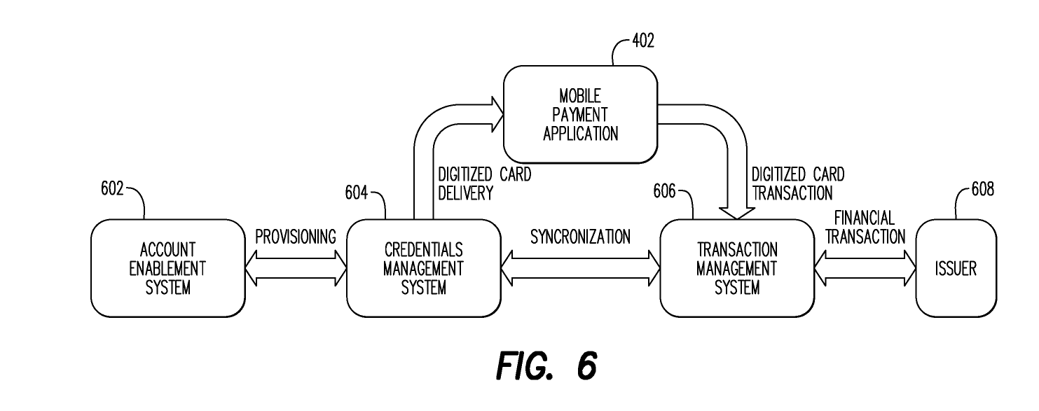

FIG. 6 schematically illustrates aspects of a payment system environment in which aspects of the present invention may be applied. More particularly, the system environment as illustrated in FIG. 6 may serve to support and enable provisioning of payment credentials or related data assets to the mobile payment app 402, while also supporting operation of the mobile payment app 402 in conjunction with payment account system transactions.

In FIG. 6, the account enablement system 602 supports digitization of payment system accounts into mobile devices. The actual provisioning of the account credentials or related data assets (e.g., cryptographic keys) is handled by the credentials management system 604 in response to the account enablement system 602. The provisioning itself is implemented via interaction between the credentials management system 604 and the mobile payment application 402. The respective account databases of the credentials management system 604 and the transaction management system 606 are synchronized with each other. The transaction management system 606 interacts with the mobile payment app 402 so as to obtain online technical authorization of transactions from the account issuer 608. (The latter may correspond to element 112 shown in FIG. 1.)

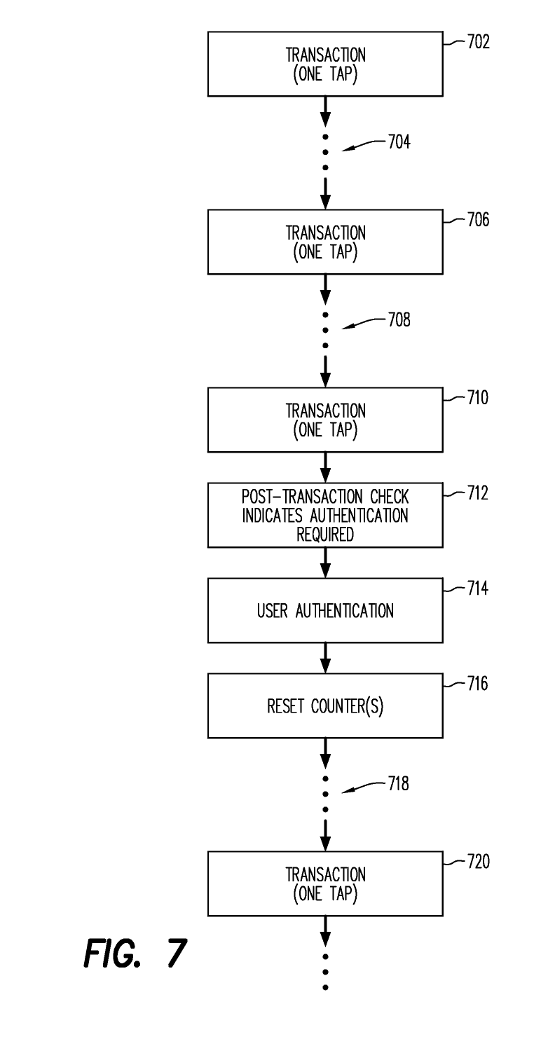

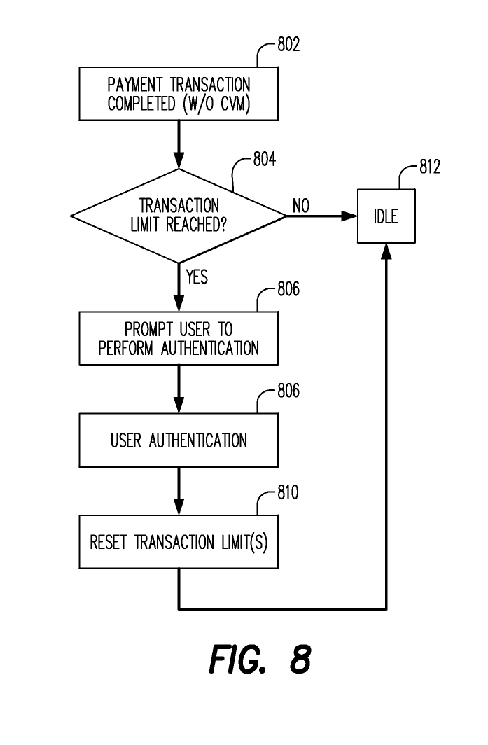

FIG. 7 is a flow chart that illustrates a process that may be performed according to aspects of the present disclosure. FIG. 7 may be viewed as a relatively high-level illustration, with additional details of teachings of the present disclosure to be discussed later in connection with FIG. 8.

It is assumed that, at the start of the process of FIG. 7, the state of the mobile app 402 is such that the current LVT-without-user-authentication limit is three transactions. Block 702 in FIG. 7 represents a first one of the permitted three LVTs, and it is further assumed that no user authentication was required or performed in connection with LVT 702, and that the transaction was accomplished in a single tap of the mobile device 102 on the contactless (payment-enabled mobile device) reader of a POS terminal.

Then, after an interval of time (schematically indicated at 704), a second LVT (block 706) takes place. Again it is assumed with respect to LVT 706 that no user authentication was required or performed and that a single tap sufficed for the transaction to occur.

Following another interval of time (reference numeral 708) after LVT 706, a third LVT (block 710) takes place. Once more it is assumed with respect to LVT 710 that no user authentication was required or performed and that once more the transaction was accomplished via a single tap of the mobile device on the POS reader (which presumably may be located at a different vendor/merchant location than the respective POS readers encountered at the LVTs 702 and 706).

The process of FIG. 7 further assumes that completion of the third LVT 710 triggers a risk management limit-warning or the like within the mobile payment app 402. For example, at block 712, the mobile payment app 402 may check a current counter of permitted LVT transactions and note that the counter in question has been decremented to zero. Accordingly, the mobile payment app 402 may determine that a user authentication process is required in the aftermath of the third LVT 710 (but not as part of or in order to accomplish the third LVT 710). Accordingly, the mobile payment app 402 may cause the user of the mobile device 102 to be prompted to engage in a user authentication process, which is performed at 714. The prompt may, for example, take the form of a distinctive audible alert, coupled with a pop-up message on the mobile device display to the effect of, “security check—please enter PIN” (assuming that entry of a wallet (e.g.) PIN and verification of the same are the applicable form of user authentication to be used). As an alternative to PIN entry or verification, another mode of user verification may be employed, including for example a biometric user authentication such as fingerprint scan and verification, or facial recognition from an image of the user's face captured by the mobile device camera, or voice recognition. Suitable prompts for these types of user authentication may alternatively be provided as appropriate.

At block 716, the mobile payment app 402 may reset one or more counters or take further action or alternative actions to allow for a further sequence of LVTs to occur without requiring user authentication during such LVTs. In other words, the action(s) taken at 716 may reflect that the user authentication has been successfully performed. In some embodiments, the further or alternative action(s) may include requesting and being provisioned with a series of cryptographic keys to be used respectively in a sequence of future transactions.

Following 716, and also following an interval of time represented at 718, another LVT 720 may take place. This may be at a different POS than the respective POS's at which the LVTs 702, 706, 710 took place. The LVT 720 may, like those indicated at 702, 706, 710, not require or include user authentication to be performed as part of the transaction.

FIG. 8 is a flow chart that illustrates a process that may be performed according to aspects of the present disclosure. FIG. 8 illustrates details of processing that were implicit in, or were not explicitly discussed in connection with, the process of FIG. 8.

At 802 in FIG. 8, a LVT (such as any of those depicted in FIG. 7) is completed. Following block 802 in FIG. 8 is a decision block 804. At decision block 804, the mobile payment app 402 may determine whether, in view of the completion of the LVT, some transaction limit has been reached that has been mandated, for example, in the interests of risk management. For example, this determination may be based on whether a velocity counter and/or a transaction limit counter has counted down to zero upon the completion of the LVT. If so, then block 806 may follow decision block 804. At block 806, the mobile payment app 402 may cause the mobile device 102 to prompt the user to perform a user authentication process. This prompt may take place, for example, a short time after the LVT completion indicated at 802. For example, the prompt may be timed to occur before the user would have returned the mobile device to his/her pocket or handbag after completion of the LVT indicated at 802.

Block 808 may follow block 806. At block 808 a user authentication/CVM may be performed, as described above. Assuming success in the user authentication process, then block 810 may follow block 808. At block 810, the mobile payment app 402 may cause the currently effective limit on LVTs to be reset (e.g., by resetting one or more counters). Following block 810, the process of FIG. 8 may idle, as indicated at 812, until the next LVT occurs and is completed. Similarly, the “no” branch from decision block 804 may lead to block 812—i.e., to idling until the next LVT occurs and is completed.

In some embodiments, the process of FIG. 8 may be triggered and performed upon completion of each of the LVTs depicted in FIG. 7.

With a mobile payment app operative as described herein, risk management in relation to LVTs and the like may be implemented in a manner that does not intrude on or interfere with smooth processing of transactions, while achieving reasonable security via occasional user authentication processes without significantly inconveniencing the device user. Accordingly a payment-enabled mobile device may be programmed with a mobile payment app with functionality as described herein to promote a favorable user experience in connection with low value transactions performed with the mobile device. Moreover, the above-described user-friendly risk management approach implemented at the level of the mobile payment app may not require any modification of the processing typically performed vis a vis the POS device or at the level of the Transaction Management System. Neither does this user experience solution via the mobile payment app require modification of operation of the Credentials Management System.

While embodiments have been described above in connection with risk management for low value transactions, the teachings of this disclosure are not so limited, and may alternatively be applied to one or more other categories of transactions or to all types of transactions in general.

In some embodiments, if the user does not respond to the prompt at, e.g., block 806 in FIG. 8, the payment-enabled mobile device may be operative such that the next unlocking operation of the device may require that the user authentication be performed. In some embodiments, if the user does not respond to the prompt at, e.g., block 806 in FIG. 8, the payment-enabled mobile device may be mute to the POS and the device may require that the user authentication be performed prior to any contactless communication with the POS. Once that user authentication has occurred, the transaction may proceed with a one-tap user experience. Moreover, in this or similar embodiments, when the payment-enabled mobile device is in a condition to be mute to the POS (i.e., the NFC transmission capabilities of the payment-enabled mobile device are disabled), detection of the NFC field from the POS by the payment-enabled mobile device may result in triggering the user authentication process (e.g., with a suitable prompt to the user); successful completion of the user authentication process would lead to resetting of counters or similar measures to enable NFC communication with the POS and allow a transaction to be made using a one-tap experience.

In some embodiments, the mobile payment app is associated with only a single payment account. In other embodiments, the mobile payment app may be a wallet app and may have several sets of account credentials associated therewith. In the latter case, each of the sets of account credentials may be associated with a respective payment app accessible via the wallet app.

In some embodiments, where the user has another device (e.g., a wearable device such as a smartwatch) linked to the payment-enabled mobile device, the prompt may be delivered—as per block 806, FIG. 8—via the other device in addition to or instead of via the user interface of the payment-enabled mobile device.

In some embodiments, the user authentication may be handled via an online interaction with a remote computer and/or by another mechanism other than via the mobile payment app as referred to above.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
completing a payment transaction using a payment-enabled mobile device; and
prompting a user to perform a user authentication process with respect to the payment-enabled mobile device after completion of the payment transaction and prior to commencing another payment transaction using the payment-enabled mobile device.

2. The method of claim 1, further comprising:
determining that said user authentication process is required, said determining step triggered by said completion of the payment transaction;
and wherein said prompting step is triggered by a result of said determining step.

3. The method of claim 1, wherein the completed payment transaction is a contactless payment transaction.

4. The method of claim 1, further comprising:
performing the user authentication process in response to the prompt.

5. The method of claim 4, wherein the user authentication process is biometric.

6. The method of claim 4, wherein the user authentication process includes receiving input of a PIN (personal identification number) and verifying the PIN.

7. The method of claim 6, wherein the PIN is verified by an application program running in the payment-enabled mobile device.

8. The method of claim 4, further comprising:
resetting a counter in the payment-enabled mobile device in response to a result of the user authentication process.

9. The method of claim 1, wherein the payment-enabled mobile device is a smartphone programmed with a payment application program.

10. The method of claim 1, wherein the completed payment transaction did not require user authentication.

11. The method of claim 1, further comprising:
disabling a short-range data communication transmission capability of the payment-enabled mobile device if the user is unresponsive to the prompting step; and
triggering another prompt to the user to perform the user authentication process if the payment-enabled mobile device senses a short-range data communication field at a time when said transmission capability is disabled.

12. A payment-enabled mobile device, comprising:
a processor; and
a memory in communication with the processor, the memory storing program instructions, the processor operative with the program instructions to perform functions as follows:
completing a payment transaction using the payment-enabled mobile device; and
prompting a user to perform a user authentication process with respect to the payment-enabled mobile device after completion of the payment transaction and prior to commencing another payment transaction using the payment-enabled mobile device.

13. The payment-enabled mobile device of claim 12, wherein the processor is further operative with the program instructions to:
determine that said user authentication process is required, said determining step triggered by said completion of the payment transaction;
and wherein said prompting step is triggered by a result of said determining step.

14. The payment-enabled mobile device of claim 12, wherein the completed payment transaction is a contactless payment transaction.

15. The payment-enabled mobile device of claim 12, wherein the processor is further operative with the program instructions to:
perform the user authentication process in response to the prompt.

16. The payment-enabled mobile device of claim 15, wherein the user authentication process is biometric.

17. The payment-enabled mobile device of claim 15, wherein the user authentication process includes receiving input of a PIN (personal identification number) and verifying the PIN.

18. The payment-enabled mobile device of claim 17, wherein the PIN is verified by an application program running in the payment-enabled mobile device.

19. A non-transitory machine-readable storage medium having stored thereon program instructions for causing the machine to perform functions as follows:
completing a payment transaction using a payment-enabled mobile device; and
prompting a user to perform a user authentication process with respect to the payment-enabled mobile device after completion of the payment transaction and prior to commencing another payment transaction using the payment-enabled mobile device.

20. The storage medium of claim 19, wherein the stored instructions further cause the machine to:
determine that said user authentication process is required, said determining step triggered by said completion of the payment transaction;
and wherein said prompting step is triggered by a result of said determining step.

21. The storage medium of claim 19, wherein the completed payment transaction is a contactless payment transaction.
